(19) United States
(12) Patent Application Publication
(10) Pub. No.: US 2016/0224754 A1
(43) Pub. Date: Aug. 4, 2016

(54) SYSTEMS AND METHODS FOR AN INTERACTIVE ASSESSMENT AND DISPLAY OF DRUG TOXICITY RISKS

(71) Applicant: Elly Hann, La Jolla, CA (US)

(72) Inventor: Elly Hann, La Jolla, CA (US)

(21) Appl. No.: 15/009,001

(22) Filed: Jan. 28, 2016

Related U.S. Application Data
(60) Provisional application No. 62/109,929, filed on Jan. 30, 2015.

(51) Int. Cl. G06F 19/00

(52) U.S. Cl. CPC G06F 19/3431

(57) ABSTRACT

A system, circuit, method and/or computer program product for interactively assessing a risk of developing drug toxicity, including a user input unit configured to receive objective and subjective information of a patient for a plurality of categories of patient data; a correlation unit configured to determine a corresponding risk value of developing drug toxicity for each category of patient data, based on the patient data received in each category; and a risk determination unit configured to determine a level of risk of a patient developing drug toxicity based on the correlated risk values.

### CROSS REFERENCE TO RELATED DOCUMENTS

The present invention claims priority to U.S. Provisional Patent Application Ser. No. 62/109,929 of Hann, entitled “SYSTEMS AND METHODS FOR AN INTERACTIVE ASSESSMENT AND DISPLAY OF DRUG TOXICITY RISKS,” filed on Jan. 30, 2015, the entire disclosure of which is hereby incorporated by reference herein.

### FIELD OF THE INVENTION

The present invention relates to systems and methods for an interactive assessment and display of a risk level of a patient for drug toxicity, and more particularly to methods and systems for identifying knowledge-based risk scores for a plurality of objective patient data and evaluating the risk scores to determine an overall risk level for developing drug toxicity, including displaying such risks as a quick clinical reference tool for a clinician at bedside as well as an interactive teaching tool for clinicians, and the like.

### BACKGROUND OF THE INVENTION

Drug toxicity in medical and recreational use is a major public safety problem. Frail patients may die when they suffer from drug toxicity, such as opioid toxicity. It also contributes to increased acute care hospital length of stay and escalates healthcare cost. Fortunately, most of it is preventable by educating the public and healthcare personnel.

When the patient receives co-prescription drugs or the body's function deteriorates, normal metabolic and excretion pathways are impaired. Drugs can accumulate in major organs and cause subclinical or full blown physical and psychiatric toxicities. There is a need for interactively assessing drug toxicity risks and visually displaying the results at patient's bedside even in absence of detailed laboratory tests.

Nurses and physicians need a tool that helps them choose the safest drugs for an individual patient. Approaches to prevention of drug toxicity are primitive, because a physician often relies on prior experiences with a particular drug or class of drugs, or consulting with two or three different databases may be necessary. Most physicians lack knowledge and experience in drug management. For example, a physician may overlook a patient's changing condition and fail to anticipate potential toxicity. Polypharmacy may bewilder even an experienced physician or a specialty nurse practitioner.

A prior art (U.S. Patent WO2012122347A1 by Shiloh September, 2012) addresses an alert system for multi-drug interactions and potential adverse reactions based on data captured in the electronic medical record (EMR). Another prior art (U.S. Patent WO2008045389A2 by Chiu April 2008) addresses using a bioinformatics software to choose appropriate chemotherapy agents. A prior art (U.S. Patent 20100235378A1 Armstrong September 2010) addresses searching patient database for adverse drug reactions. For visually-oriented adult learners, however, there is an absence of visually distinctive display of drug toxicity risks for an individual patient, nor is there an interactive tool for assessing drug toxicity risks that also functions as a teaching tool of complex and changing drug research data.

In view of the foregoing, there is a need for systems and methods to interactively assess the risks of drug toxicity at point of care and display the results in a visually distinctive and memorable way appropriate for an adult learner.

### SUMMARY OF THE INVENTION

Embodiments described herein are directed to systems and methods for interactively assessing a risk level for drug toxicity. The risk level is determined using individual risk scores provided for a plurality of objective patient data categories based on correlations in risks of toxicity development in those categories. A user provides input patient data on a plurality of patient health factors, either from an electronic medical record or at bedside, after which pre-determined risk scores for the inputted patient data are identified. The risk scores are then used to determine an overall risk assessment level of the patient for developing drug toxicity. The system and method can be applicable regardless of patient care setting, such as home care, nursing home, acute care hospital, etc. The system and method can receive patient data from an input device and calculate a risk level for the patient based on the patient data and assigned risk scores, and then outputs the risk level to a user on a display. The system and method can further function as an interactive teaching tool when parameters of input values change, the result of which determine a different assessed risk level, which is accompanied by a display of different risk level and a different set of explanations for the risk level. The system ad method can present groups of patients according to risk levels on an electronic screen to be viewed by multiple users, improving user's workflow and continuity of care. The system and method can export drug toxicity risk level data to a patient outcomes reports form. The system and method can visually display on a user's preferred device or send voice alerts of risk levels of drug toxicity.

Accordingly, in an exemplary aspect, there is provided a system, circuit, method and/or computer program product for interactively assessing a risk of developing drug toxicity, including a user input unit configured to receive objective and subjective information of a patient for a plurality of categories of patient data; a correlation unit configured to determine a corresponding risk value of developing drug toxicity for each category of patient data, based on the patient data received in each category; and a risk determination unit configured to determine a level of risk of a patient developing drug toxicity based on the correlated risk values.

The system, circuit, method and/or computer program product can include a user interface configured to display different components of risk assessment including a metabolic pathway of a drug, an excretion pathway of a drug, potential drug sensitivity of a patient from prior experience, drug-to-drug and drug-to-food interaction, and Cytochrome P450 genotype.

The system, circuit, method and/or computer program product can include a remote connection mechanism including a telemedicine connection, and a web server connecting to an appropriate application, for a user to virtually assess a patient, input patient data, and calculate a risk level of drug toxicity for the patient in real time.

The system, circuit, method and/or computer program product can include a user interface configured to display risk levels corresponding to correlated risk values; a multi-user platform configured to allow viewing of risk levels for allocation of clinician coverage in real time; and a trend system configured to allow tracking of progress of an individual patient and accessible from a remote location.

The system, circuit, method and/or computer program product can include a user interface configured to display different toxicity result levels accompanied by corresponding explanations for each of drug toxicity risk accompanied by suggestions of safer drug choices to mitigate drug toxicity, wherein each explanation is referenced for further reading.

The system, circuit, method and/or computer program product can include a sorting system configured for sorting of patients with similar risk levels; a display unit configured for representing by color indicators of similar risk levels; a display screen or printable sheet for at-risk patients to improve clinician workflow; an assessment tool configured for allowing for appropriate follow up for at-risk patients, including a visual screen configured for displaying at-risk patients simultaneously; a visual system configured for improving continuity of care during shift changes; a display device for submitting drug toxicity risks to patient outcomes reports, including a user interface configured to display when a risk level of a patient is at a predetermined level, and an inputted check list for drug toxicity prevention; an automated documentation tool for clinicians configured to verify that drug toxicity prevention tasks are completed, including an automated process between drug toxicity assessment with data input completion of patient outcomes reports; a user interface for real-time measurement of patient outcomes quality indicators, and a quality measurement linked to an individual user for an archived period; a user interface for continuously transmitting drug toxicity risk levels; an electronic message sharing system configured to send a message to a user group regarding drug toxicity risk levels; a user interface for automated, updated assessment of risk level when a clinical condition of a patient changes, including automated reporting of urine output; a documentation system configured for documenting when a clinician chooses a safer drug; a user interface configured for interactive assessment for drug toxicity risk, wherein the user can change a variable input to view a changed display of toxicity level, accompanying explanations, and suggestions for alternate drugs; and a user interface including a teaching tool that demonstrates various toxicity risk levels according to changing clinical parameters.

From this description, in conjunction with other items, the advantages of the said invention will become clear and apparent more so based upon the hereinafter descriptions and claims, which are supported by drawings with numbers relating to parts, wherein are described in the following sections containing the relating numbers.

### BRIEF DESCRIPTION OF THE DRAWINGS

The accompanying drawings, which are incorporated in and constitute a part of the specification, illustrate embodiments of the invention and, together with the description, serve to explain the objects, advantages, and principles of the invention. In the drawings:

FIG. 1 is a flow diagram illustrating a user login, entering patient assessment either manually or electronically from a telemedicine portal or an electronic medical record, selecting a drug from a drug category, and inputting the patient data, according to one embodiment of the invention;

FIG. 2A is a drawing illustrating a set of patient health factors which comprise patient data, according to one embodiment of the invention;

FIG. 2B is a flow diagram illustrating a set of patient health factors with associated response, according to one embodiment of the invention;

FIG. 2C is a flow diagram illustrating an interactive function which demonstrates the relationship between a drug toxicity level from one set of patient health care parameters as opposed to a different drug toxicity result when healthcare parameters change, according to one embodiment of the invention;

FIG. 3 is a flow diagram illustrating the method of assessing drug toxicity result and its display, according to one embodiment of the invention;

FIG. 4 is an illustration of a set of four possible results displayed to the user, according to one embodiment of the invention;

FIG. 5 is drawing illustration of a set of four possible toxicity risk results representing four different levels of risks, which are accompanied by a set of different explanations, according to one embodiment of the invention;

FIG. 6 is a table illustrating a list of an individual patient's drugs and display of multiple drug toxicity risk levels, according to one embodiment of the invention;

FIG. 7 is a flow diagram illustrating how drug toxicity risk results can shared with other team members by various communication modalities, send alerts, and export to quality measures outcomes report, according to one embodiment of the invention;

FIG. 8 is a sorting table illustrating patient sorting by plurality of patients' drug toxicity risk levels, according to one embodiment of the invention;

FIG. 9 is a table illustrating the drug toxicity risk assessment as a quality outcomes tool, a performance and improvement tool, according to one embodiment of the invention;

FIG. 10 is a flow diagram illustrating an automated reminder of check list that contribute to drug toxicity risks for a given drug-host interaction, according to one embodiment of the invention;

FIG. 11 is a block diagram illustrating a computer/server system upon which an embodiment of the invention methodology can be implemented;

FIG. 12A is a graph and a flow diagram illustrating a relationship between input variables and an interactive output display;

FIG. 12B is a more detailed graph and a flow diagram illustrating a relationship between input variables an interactive output display;

FIG. 12C is a flow diagram illustrating a hover feature of designated toxicity risk dots;

FIG. 13 is a graph illustrating multiple drug toxicity risk results shown simultaneously; and

FIG. 14 is a graph illustrating various functions to promote knowledge sharing.

### DETAILED DESCRIPTION OF PREFERRED EMBODIMENTS

After reading this description it will become apparent that one skilled in the art can implement the invention in various alternative embodiments and alternate applications. However, all the various embodiments of the present invention will not be described herein. It is understood that the embodiments presented here are presented by way of an example only, and not limitation. As such, this detailed description of various alternative embodiments should not be construed to limit the scope or breadth of the present invention as set forth below.

The present invention recognizes that drug toxicity can develop in any patient regardless of their clinical condition, however morbidity and mortality rates of frail patients exposed to drug toxicity are considerably higher. Drug toxicity may cause hastened death in hospice patients or precipitate in an unwanted hospital emergency room visit.

The extent or cost of drug toxicity in the United States are not accurately known due to lack of reporting or awareness, although prescription opioid overdose, for example, has surpassed automobile accidents as the leading cause of accidental deaths in certain age groups.

Approaches to prevention of drug toxicity lack a cohesive linking of a drug, its broad metabolic pathways, elimination pathways, and genotype or idiosyncratic drug sensitivities of an individualized patient. Invariably, understanding genomics and pharmacology is necessary for clinicians whose expertise may lie outside these disciplines.

Generally, methods and systems described herein allow a user to input patient data and receive an output risk level for that patient which assesses the patient's risk of developing drug toxicity against a particular drug. The patient data is a combination of objective and subjective input and allows for inputting information on multiple different categories, or patient health care input variables, related to a drug list from the drug database and the patient's health. Input variables can also include use of a plurality of sensors, such as flow sensors of a urinary catheter, for instance. Each of the categories includes a risk score for that category, which assesses a risk of the patient developing drug toxicity based upon the information input for that particular category. Once the user has input all of the requested patient data, the system evaluates the risk scores for each of the categories of patient data and outputs an overall risk level result of the patient's risk of developing drug toxicity. Patient's assessed risk level may change based on inputting a different patient health care variable.

The systems and methods allow a user, such as a nurse, healthcare professional, caretaker or even the patient to enter patient data and automatically view one of the four states of risk level indicated by a color-coded risk level indicator. The systems and methods avoid the requirement for manually having to look up each category of risk and increase the accuracy of drug toxicity risk level assessment. Input values can be uploaded from an existing electronic medical record system. Sharing the risk assessment result can improve the workflow and interdisciplinary group's coordination of care.

The systems and methods can be implemented as software running on a computer or on any mobile device or hosted by a server on a network, so that a plurality of users can access the methodology to continually input new data and provide updated risk level assessments for patients.

In one embodiment, the system stores the overall risk level for each patient over a period of time during several separate risk assessments, such that an overall pattern of risk level can be analyzed to determine if the patient is becoming more or less at risk for developing drug toxicity. The risk levels can be stored for auditing purposes as well. The system can also store the patient data input by the user for the plurality of patient categories, as this data can be used for future analytic applications and for audit purposes as well. In one embodiment, if a particular category of patient data is not input by the user, the system can trigger an audit to determine why the category was not entered or determined.

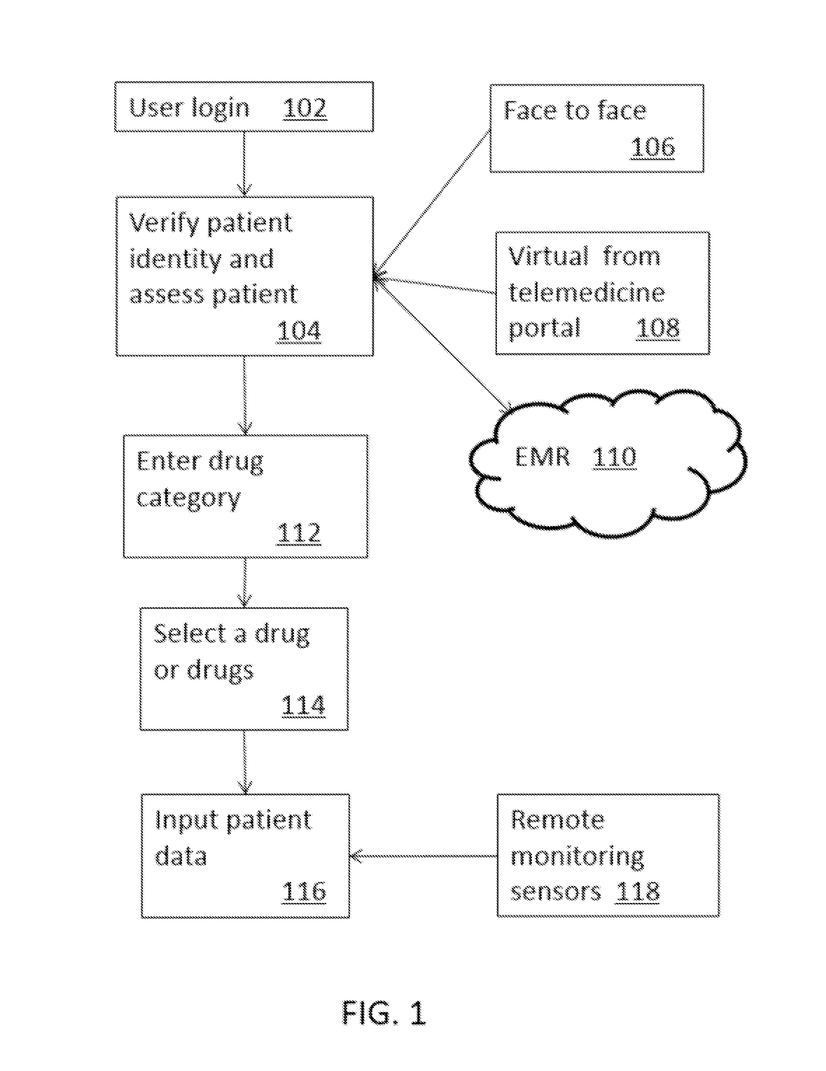

One embodiment of the system and method is illustrated in FIG. 1A, whereby the user inputs user data 102 which identifies relevant information about the user. The user completes Patient Assessment 104, which can be completed face-to-face 106, virtually through a telemedicine portal 108, or by accessing patient's electronic medical record (EMR) data. Patient identification data can be input from Patient Assessment 104. Remote monitoring sensors 118, such as urine output monitoring device, can input data directly to Patient Data 116. The user chooses one or more drugs 114 from a drug category 112 to assess its drug toxicity risk. Patient Data 116 is composed of plurality of subjective and objective categories.

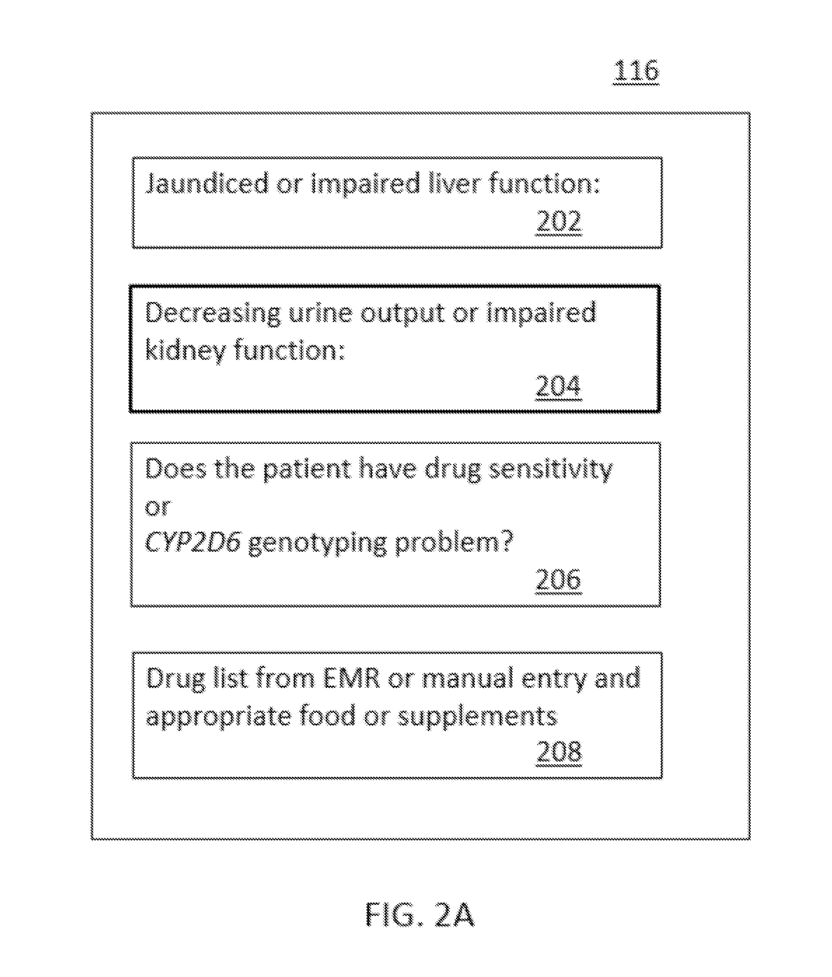

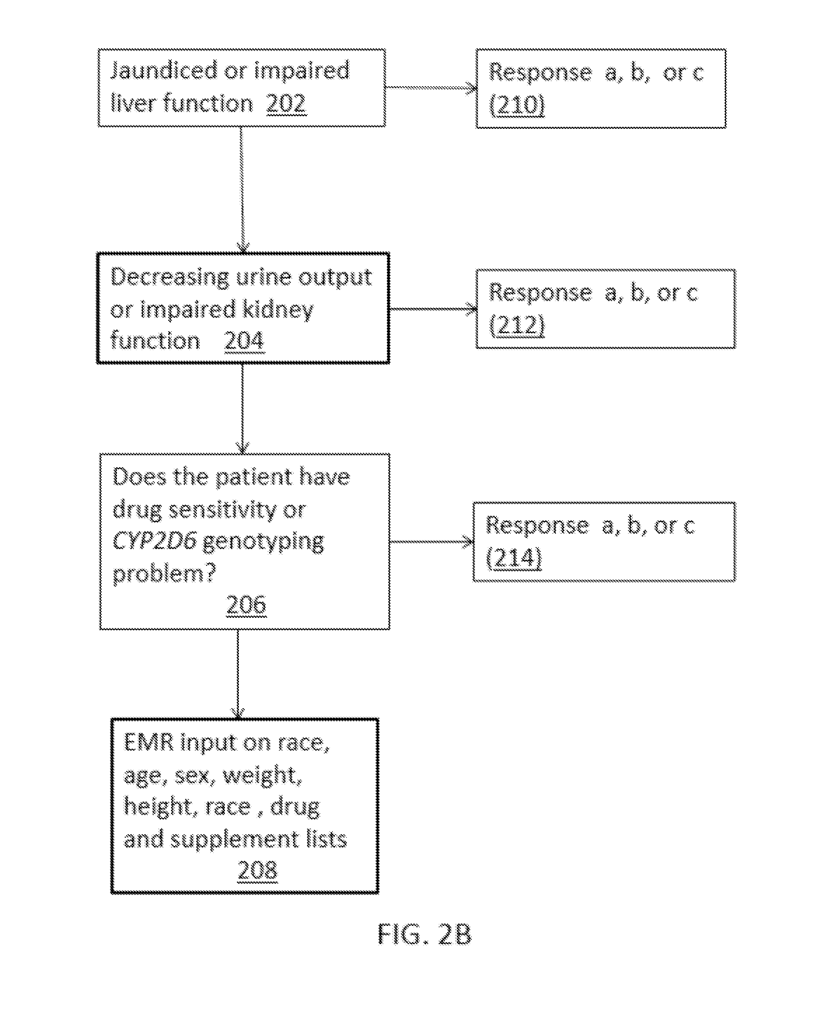

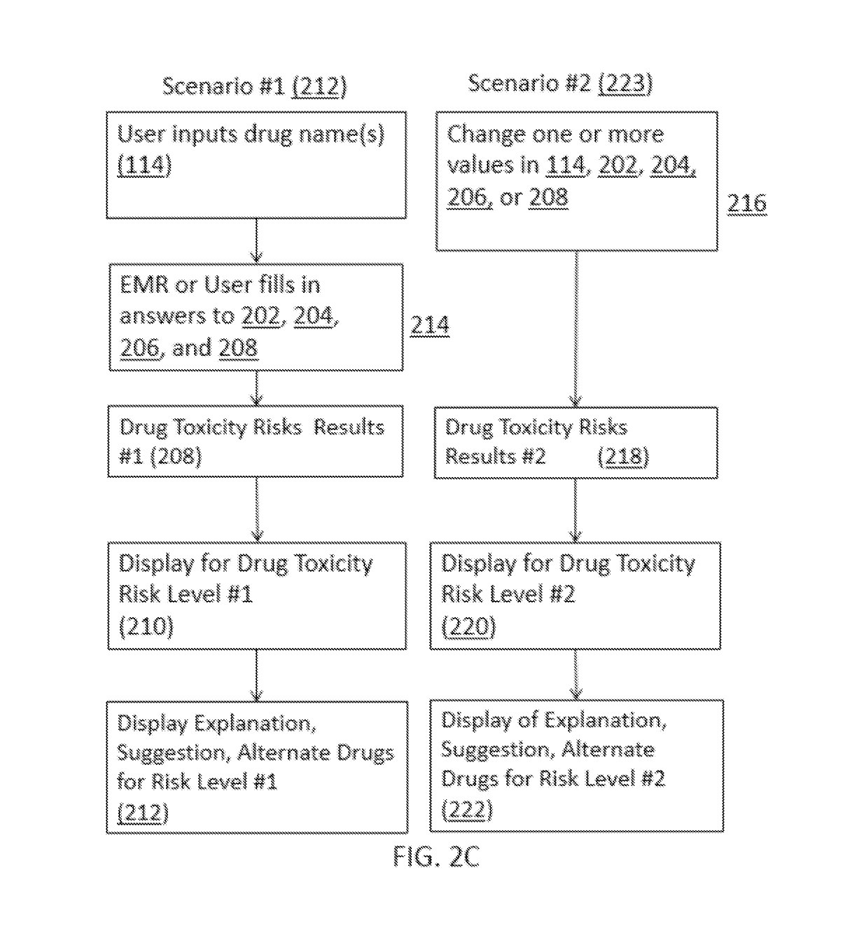

FIG. 2A is a user interface displaying set 116 of plurality of subjective and objective inputted patient data, organized in such a manner that reflects the natural order of drug behavior in a living patient. Once a drug enters the body, it must first be broken down or metabolized, as represented by the first category 202 within the set 116 of Patient Data. After metabolism, a drug must be eliminated, whereby second category 204 within the set 116 is presented. Further modification of a drug behavior by the patient's unique characteristics is represented in the third 206 and fourth category 208 within the set 116.

Responses to each Patient Data category illustrated in FIG. 2B represents a patient's capacity for metabolizing the drug 202, capacity for excreting the drug 204, and presence or absence of potential idiosyncratic drug behavior 206, 208 for the individual patient.

Each drug within a drug category database has a corresponding stored risk value associated with a response in 208, 210, 212 in FIG. 2B. This association determines a specific level of toxicity risk, thereby rendering the present embodiment an interactive drug toxicity software. The risk values can be determined based on any suitable methodology which evaluates drug's toxicity risks for each possible data entry in each drug category. If applicable, input from 208 weighs in as an additional determinant to the risk level assessment. The risk values can be determined from clinical data, generally accepted medical literature and research, and other medical knowledge from literature or a user, and the like. Additionally, the risk values can be updated regularly to reflect changes in patient condition through a patient monitoring sensor, such as urine output sensor, laboratory tests, genotype testing, and the like, in medical knowledge or analysis of past data, all of which can input Patient Data.

FIG. 2C is a flow diagram illustrating different drug toxicity risks when any of the responses 208, 210, 212 are changed. Scenario number one 212 exemplifies drug toxicity risk number one 208, accompanied by the display for the toxicity 210 and the explanation, suggestion, alternate drugs 212 for scenario number one. Whereas scenario number two 223 exemplifies a different drug toxicity risk number two 218, accompanied by the display for the toxicity 220 and the explanation, suggestion, alternate drugs 222 for scenario number two. When the user can see in real-time different risk levels as patient data variable input change, an opportunity for better understanding drug toxicity is presented.

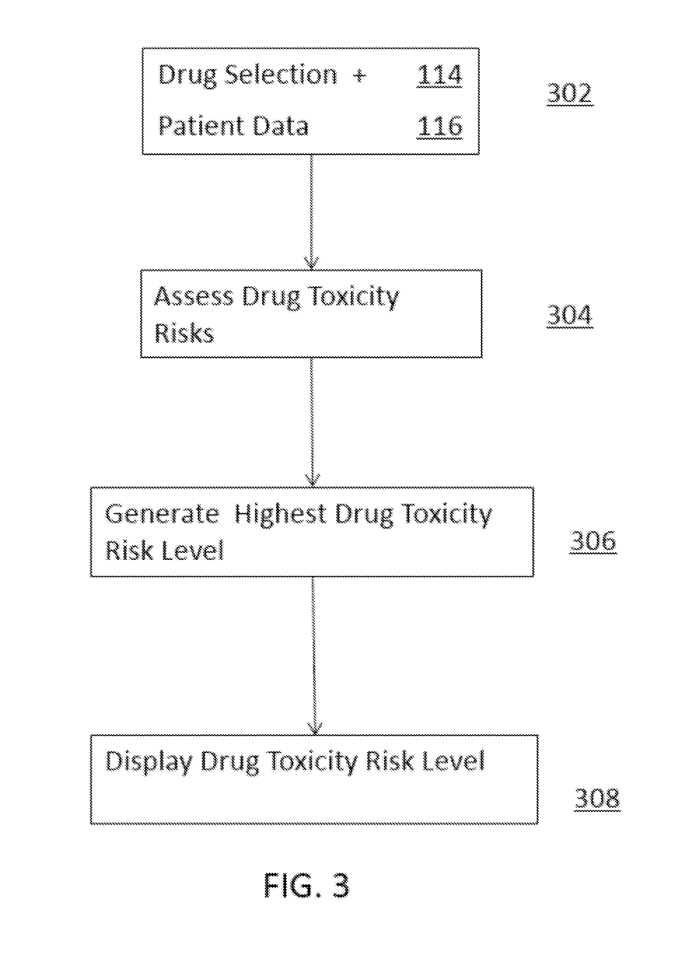

In FIG. 3, when Drug Selection 114 and Patient Data 116 are entered 302, the system and method assesses a risk level for the patient 304 based on the risk values corresponding to each of the patient data categories. In one embodiment, the determination of the risk level can be made by looking for the highest risk score associated with the input data of the patient data categories 306. The risk level can be determined by evaluating more than one risk score to provide some type of weight or other valuation factor to one risk score depending upon its significance (i.e. or its insignificance). The risk level defaults to the highest risk to reflect an overall warning to a particular drug use regardless of the risk score of each category. For example, if a patient who has “Decreasing urine output or impaired kidney function” for an entered drug 114, then a risk level of High can be output to the user if impaired kidney function contributes to a High risk level. However, the same patient data entered into the “Jaundiced or impaired liver function” category may indicate a level of Low or Moderate and an overall risk level of High is assessed.

In FIG. 3, The Drug Toxicity 302 assesses an overall toxicity risk level 304 based on Drug selection 114 and Patient Data 116, whereby the highest drug toxicity level result 304 displays output 308 to the user.

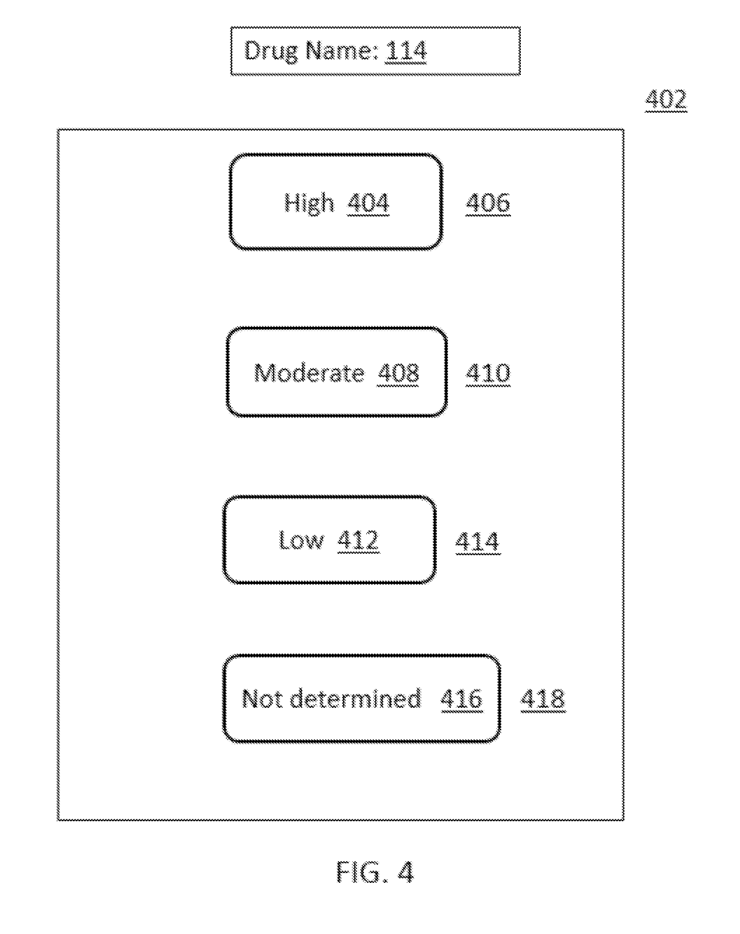

FIG. 4 is a user interface displaying four states 402 of toxicity risks for each drug 114, each represented by a distinctive and ubiquitous color. Bold colors serve as a warning when the user should be cautious. Toxicity risk in red color 404 is a symbol for High risk 406, followed by yellow color 408 for Moderate risk 410, and Low risk 412 in green color 414. No color 416 is designated to the state of Not Determined 418.

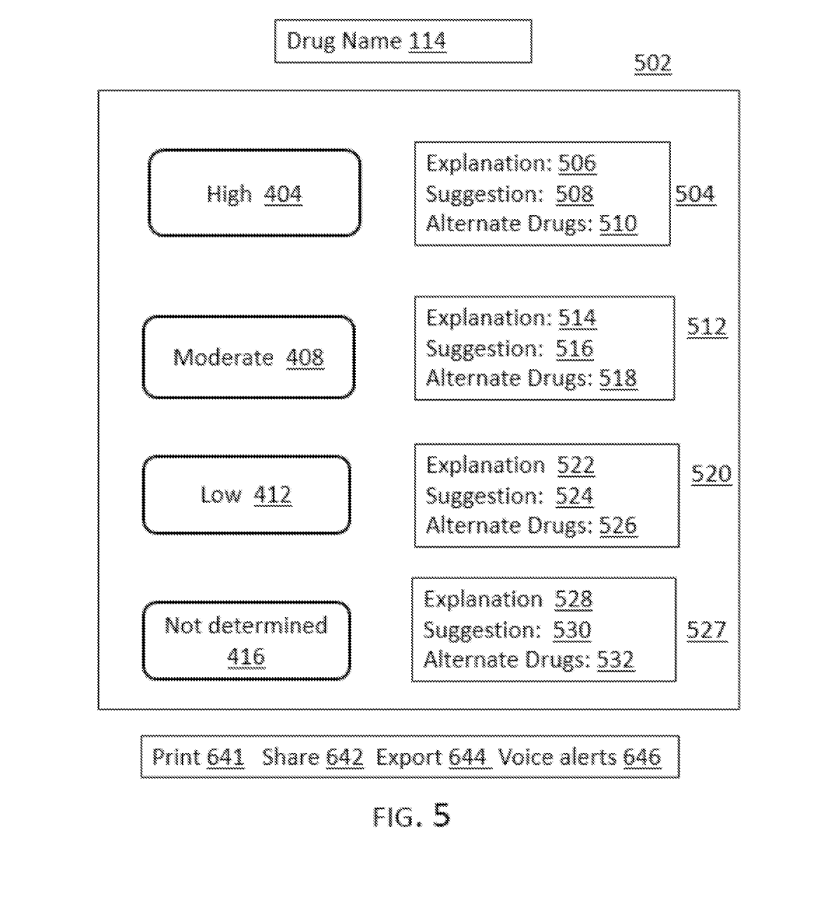

Some adult learners recall information more easily when visual information is displayed with an explanation. FIG. 5 is a user interface displaying a set 502 of four, color-coded risk levels 404, 408, 412, 416 paired with four, descriptive text boxes 504, 512, 520, 527 that explain the reasons for the assigned toxicity risks. Each text box offers an Explanation for the risk level result 506, 514, 522, 528, followed by a clinical Suggestion 508, 516, 524, 530 and a list of Alternate Drugs 510, 518, 526, 532. For example, Morphine Sulfate in the Drug Name box 114 for this patient may show High risk 404, which is paired with text box 504 describing an Explanation 506 of decreasing urine output or impaired kidney function, with Suggestion 508 to discontinue the drug and select Fentanyl for an Alternate Drug 510. On the other hand, Morphine sulfate may be assessed as Moderate risk 408 for toxicity for the same patient, in which case the text box 512 describing a different Explanation 514, Suggestion 516, and Alternate Drugs 518 will be displayed to the user. If the patient has normal kidney function and liver function, then Morphine sulfate is Low risk 412 with an accompanying text box 520 with a different set of Explanation 522, Suggestion 524, and no need for Alternate Drugs 526. A drug which cannot be assigned a risk level based on the latest evidence-based research criteria, Not Determined risk level 642 is assigned with Explanation 528, Suggestion 530, and Alternate Drugs 532. Print 641, Share 642, Export 644, or Voice Alerts 646 can be used for efficient team work.

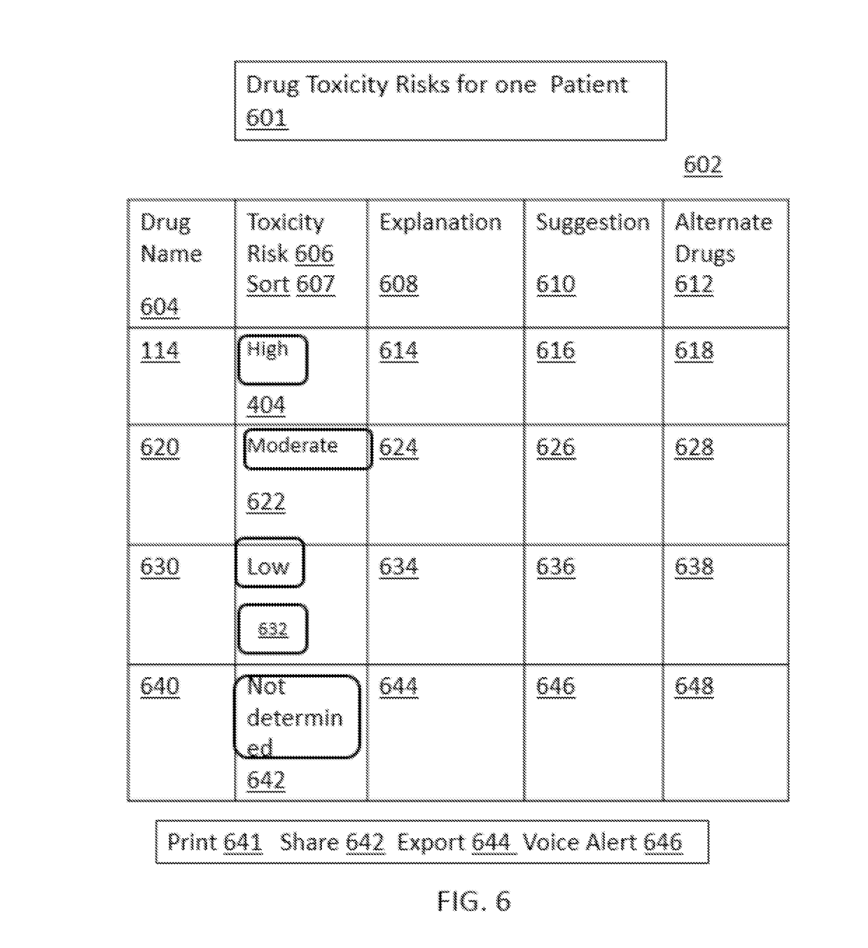

In pain management, it's a common practice for a patient to be prescribed a long-acting scheduled opioid and a short-acting opioid for breakthrough pain. FIG. 6 is a user interface displaying a table with multiple drug toxicity risks for an individual patient 601. Columns are headed by Drug name 604, Toxicity Risk 606, Explanation 608, Suggestion 610, and Alternate Drugs 612. For example, a Patient 601 who is prescribed a long-acting opioid 114 which carries a High risk level in red-colored bar 404, and Explanation 614 for the toxicity, Suggestion 616, Alternate Drugs 618 are displayed to the user. If the patient also takes a short-acting opioid for breakthrough pain, second drug 620 may display Moderate Risk in yellow-colored bar 622, with Explanation 624, Suggestion 626, and Alternate Drugs 628 respectively. Likely, a third drug 620 may be a Low toxicity risk drug 632, with Explanation of why 634, Suggestion 636, and possibly no Alternate Drugs 638. A fourth drug may show Not Determined toxicity risk 642, with Explanation 644, Suggestion 646, and Alternate Drugs 648. Each page can be printed 641, shared 642, exported 644, or receive Voice Alert 646. Risk level column 606 can be sorted 607 for a comprehensive understanding of highest toxicity risk drug to the lowest risk.

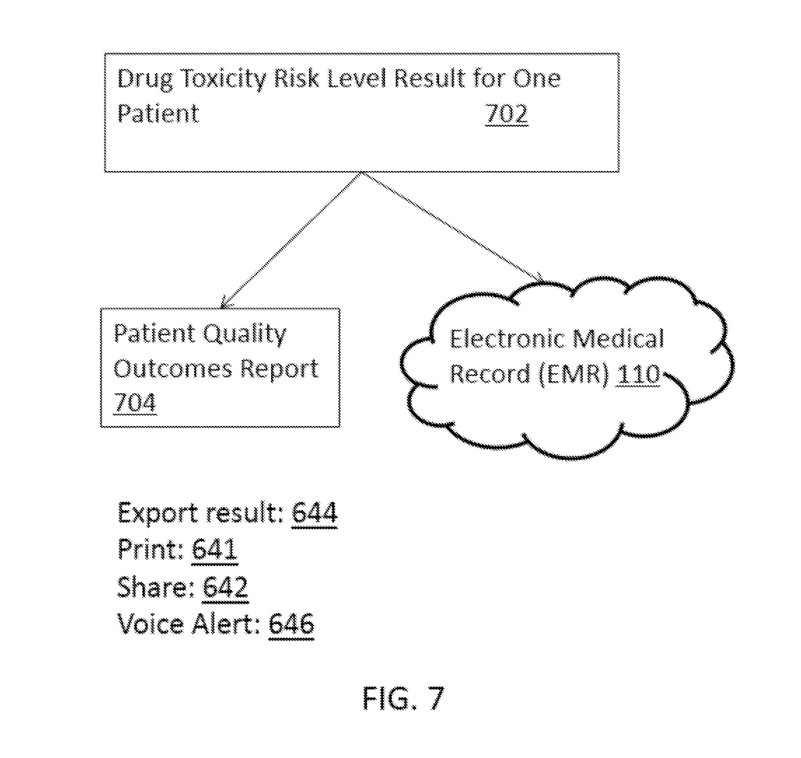

The user may prefer to share the result of the drug toxicity risk or export to other quality reports or EMR. In FIG. 7, patient's Drug Toxicity Risk Level Result 601 can be exported 705 to Patient Quality Outcomes Report 704 or to patient's EMR database 110. Workflow and interdisciplinary group coordination of care are important aspects of a good team work. Share 642 can send the risk result to the user's email, text message, or voice mail or trigger a Voice Alert 648.

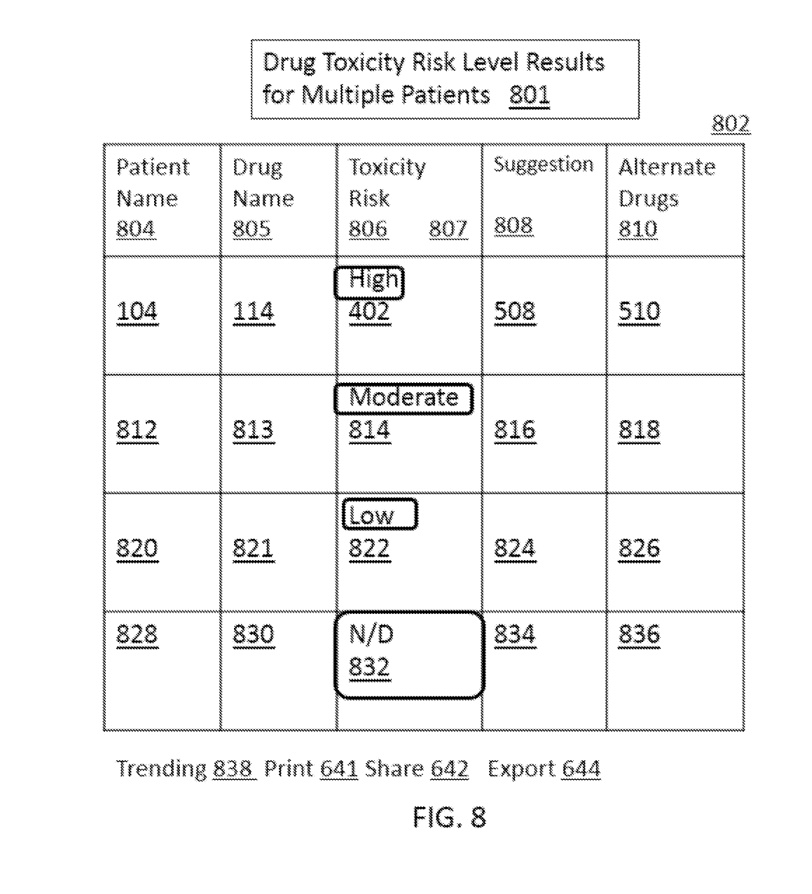

FIG. 8 is a user interface displaying drug toxicity risk level results for multiple patients 801. Assessed risk levels for multiple patients can be sorted according to the risk levels in a color-coded state as illustrated in table 802. In one embodiment, the user selects the type of patients presented on the display screen. Columns are headed by Patient Name 804, Drug Name 805, Toxicity Risk 806, Suggestion 808, and Alternate Drugs 810. Toxicity Risk 806 can sort patients from the highest risk level 402 to Moderate risk 814 Low risk 822 or Not Determined 832. Patient Name in cells 104, 812, 820, 828, Drug Name cells 114, 813, 821, 830, Suggestion cells 508, 816, 824, 834, and Alternative Drugs cells 510, 818, 826 toggle when the Risk Level is sorted. Trending 838, Print 641, Share 642, and Export 644 can help with the team workflow and the team's priority.

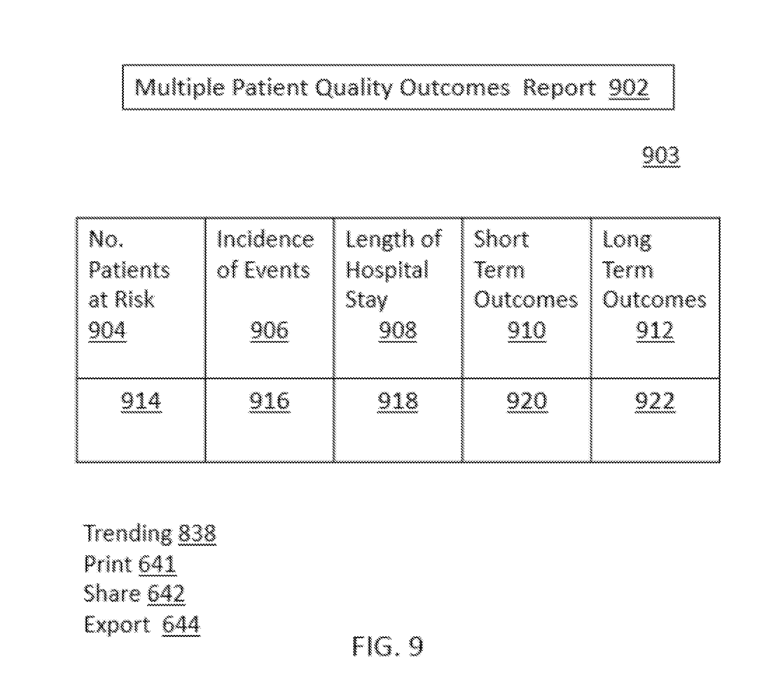

FIG. 9 is a user interface displaying a table illustrating a Multiple Patient Quality Outcomes Report focused on drug toxicity risks 902. Table 903 is a Patient Quality Outcomes Report comprised of Number of Patients at Risk 904, Incidence of Events 906, Length of Hospital Stay 908, Short-Term Outcomes 910, and Long-term Outcomes 912. For example, number of patients 914 may suffer from reported events of drug toxicity incidence 916. Correlation with Length of Hospital Stay 918, Short-Term outcomes 920, and Long-Term Outcomes 922 may be explored for continued patient quality improvement. Trending 924 can indicate areas of improvement.

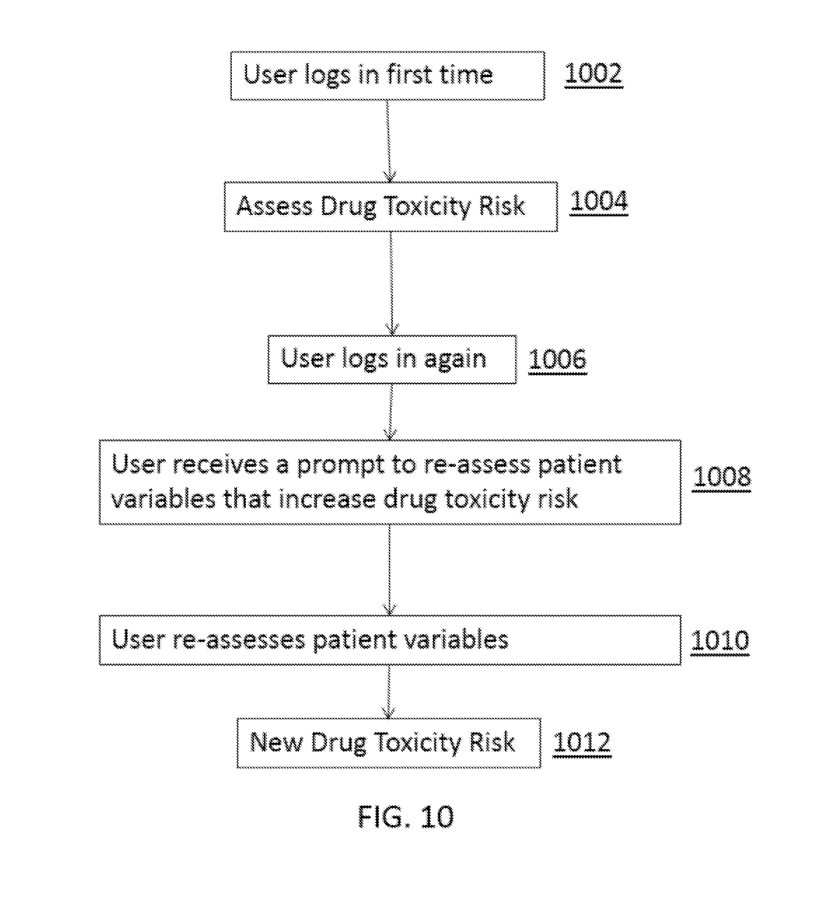

FIG. 10 is a flow diagram illustrating a machine learning opportunity of the software. The user logs in first time 1002 with assessed drug toxicity risk 1004. When the user logs in again, the user is prompted to re-assess patient data variables that can increase drug toxicity risks. For example, a patient who is prescribed Morphine Sulfate may be assessed Low risk level initially. When the user logs in again, a prompt asks the user to re-assess patient's kidney function because kidney dysfunction increases the drug's toxicity risk.

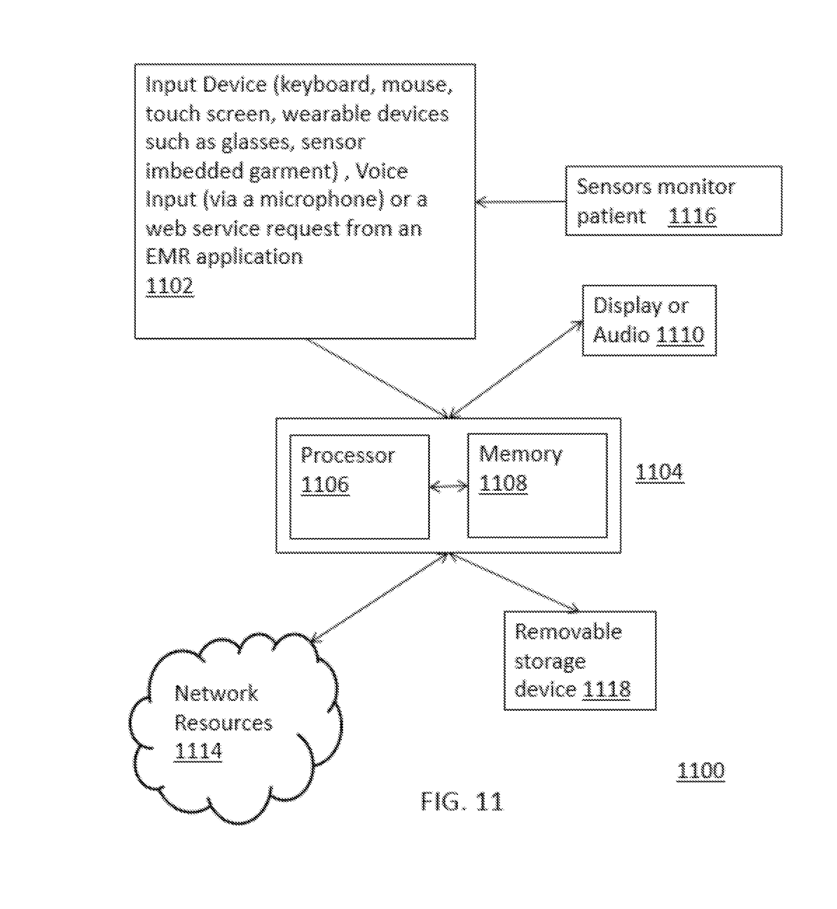

FIG. 11 is a block diagram that illustrates an embodiment of a computer/server system upon which an embodiment of the inventive methodology can be implemented. The system 1100 includes a computer/server platform 1104 including a processor 1106 and memory 1108, which operate to execute instructions and maintain a database. The term “computer-readable storage medium” as used herein can refer to any tangible medium, such as a disk or semiconductor memory, that participates in providing instructions to processor 1106 for execution. Additionally, the computer platform 1104 receives input 1102 from an EMR as well as a plurality of input devices, such as keyboard, mouse, touch screen device, wearable device such as glasses, sensor imbedded garment, or a Voice Input (via a microphone). The computer platform 1104 can additionally be connected to a removable storage device 1118, such as a portable hard drive, optical media (e.g., CD or DVD), disk media or any other tangible medium from which a computer can read executable code. The computer platform can further be connected to network resources 1114, which connect to the Internet or Intranet or other components of a local public or private network. Remote monitoring via sensors 1116 can input to an EMR or a device 1102. The connections to the network resources 1114 can be via wireless protocols, such as the 802.11 standards, Bluetooth or cellular protocols, or via physical transmission media, such as cables or fiber optics, or telephone. The network resources can include storage devices for storing data, HIPAA-compliant remote server, and executable instructions at a location separate from the computer platform 1104. The computer interacts with any suitable type of display on a mobile-device or a PC, or voice-activated audio system 1010 to output data and other information to a user on a responsive-screen, as well as to request additional instructions and input from the user. The display 1110 can therefore further act as an input device 1102 for interacting with a user.

The computer/server system 1100 can be implemented, for example, for an anonymous patient user, and include a standalone executable program. Any suitable user can access such program via the internet or any available mobile technology, or have another user input data remotely via telephone. The result can be displayed or verbally presented or printed for view.

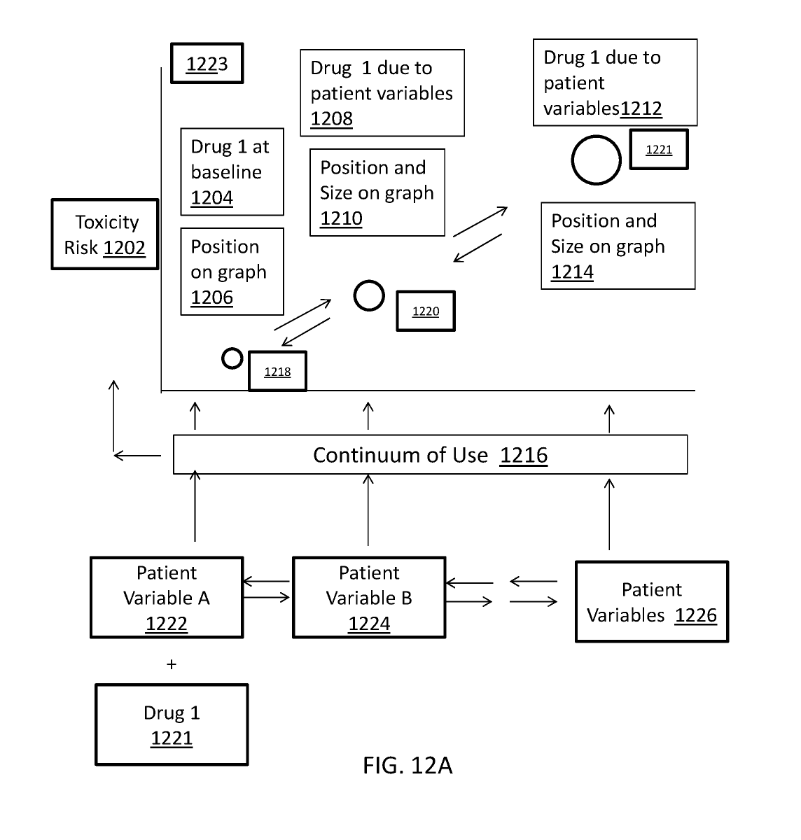

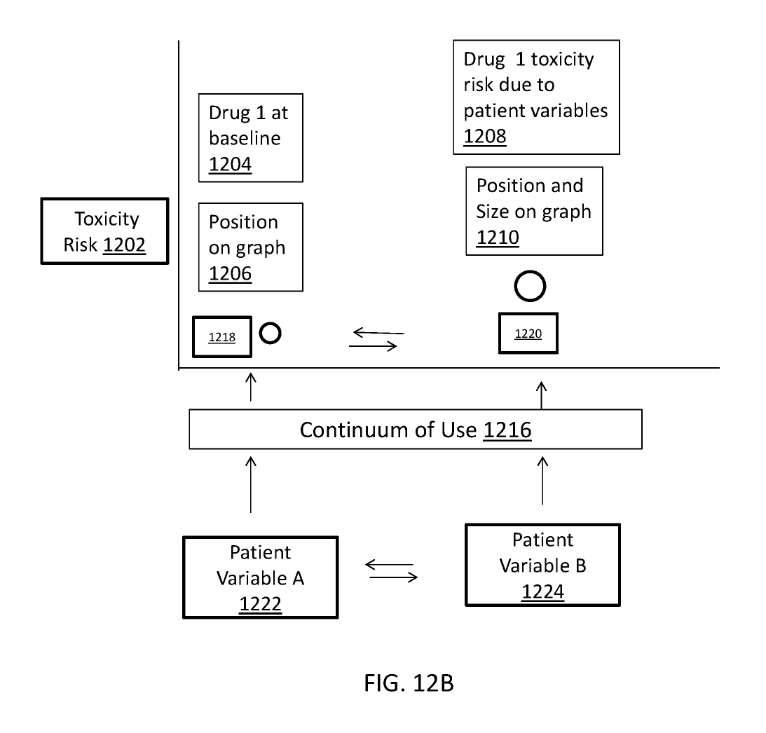

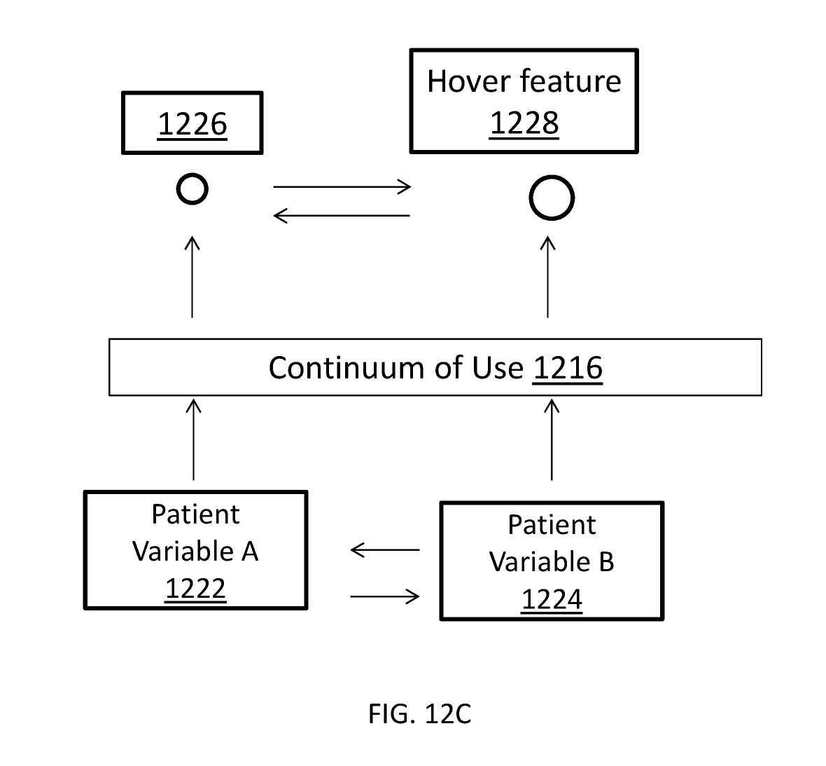

The previously described illustrative embodiments of FIGS. 1-11 provide systems and methods for assessing drug toxicity risks in individual patients, whereby a drug's effects on varying patient variables is calculated, and the like. FIG. 12A is a graph and a flow diagram illustrating a drug 1221, which interacts with patient variables 1222, 1224, and 1226. In this illustrative embodiment, the system and method can be used to assess a drug's toxicity risks, and display relevant outputs, for example, in an interactive display panel 1223, and the like, including Continuum of Use 1216 on an x-axis, and Toxicity Risk 1202 on a y-axis, as shown.

The assessed drug toxicity risks determine and correlate, for example, with a circle size of dots 1218, 1220, and 1221 on the graph, as well as their positions 1206, 1210, and 1214, and on a Continuum of Use (e.g., color bar). For example, a drug 1204 with low toxicity risk can be positioned in a left lower corner 1218, and gradually move to the right upper corner 1221, as the toxicity risk increases, as does a color indicator in the Continuum of Use bar 1216 (e.g., due to patient variables shown at 1208 and 1212).

Often, initially assessed drug toxicity risks may decrease when a patient's condition improves, for example, as illustrated in FIG. 12B. Indicated by a reverse arrow from positions 1210 to 1206, a patient whose clinical condition improves may be able to metabolize and eliminate drugs more efficiently and become safer. Such a change is reflected in the color indicator Continuum of Use bar 1216. The reverse arrow from Patient Variable B 1224 to Patient Variable A 1222 reflects the fact that when one organ recovers, the burden of metabolizing and eliminating the drug and its metabolites is more equally shared among patient variables. An added useful feature of the embodiment is illustrated in the Hover functionality 1226, 1228 in FIG. 12C. For example, when a user hovers over each dot circle, detailed drug information and other useful learning points are displayed, all of which are designed for improved recall.

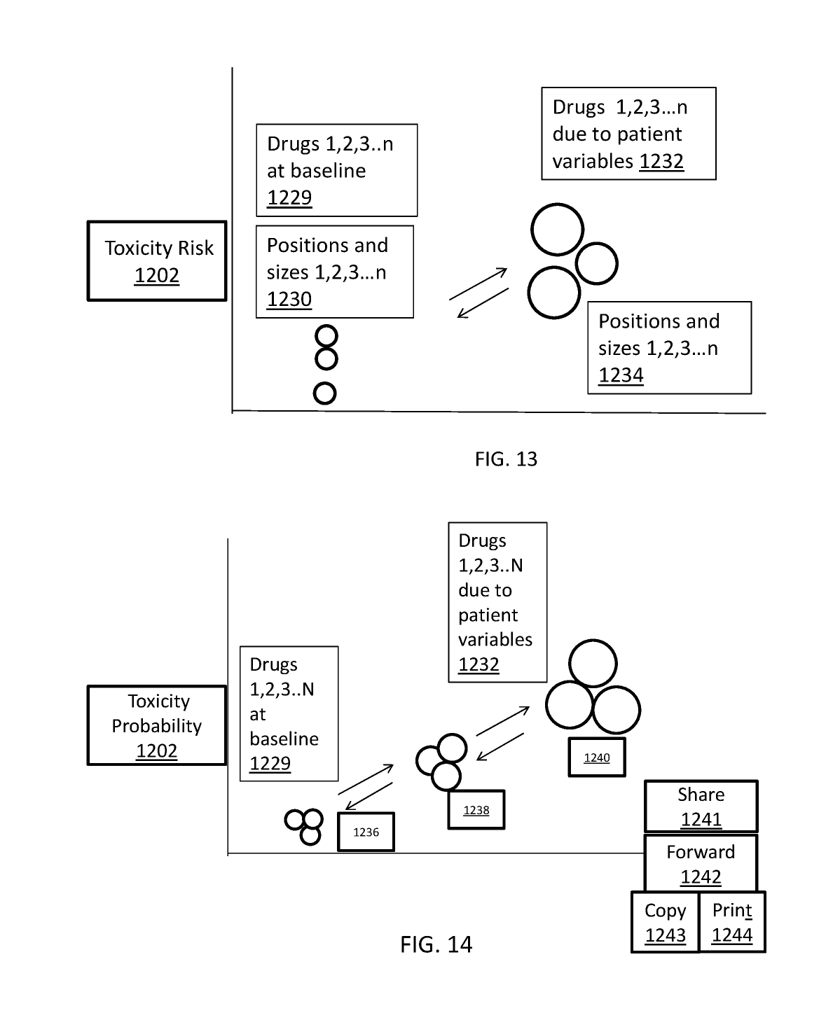

Drug applications may typically show one drug at the time without the aid of a visual application. However, in a further illustrative embodiment, the system and method can group and display several drugs, for example, grouped together at 1229 and 1232 by their toxicity risks, at respective positions 1230 and 1234, and the like, as illustrated in FIGS. 13-14. Systematically grouping drugs together at 1229, and 1232 by toxicity risks 1230, and 1234 offers an added advantage for the user, who can choose a drug within their formulary list of insurer-covered drugs, and the like. For example, Groups of drugs 1229 may start at baseline of low toxicity at positions 1230 to move later to varying groups 1232 with corresponding toxicity risks at positions 1234, and as shown at 1236, 1238 and 1240. Enhanced interactive display features may include a share feature 1241, a forward feature 1242, a copy feature 1243, and/or a print feature 1244, and the like, adapted for various technology platforms, and the like.

Accordingly, above-described device and subsystems of the illustrative embodiments can include, for example, any suitable servers, workstations, PCs, laptop computer, PDAs, Internet appliances, handheld devices, cellular telephones, wireless devices, iPad, Android devices, and the like, capable of performing the processes of the illustrative embodiments. The devices and subsystems of the illustrative embodiments can communicate with each other using any suitable protocol and can be implemented using one or more programmed computer systems or devices.

One or more interface mechanisms can be used with the illustrative embodiments, including, for example, Internet access, telecommunications in any suitable form, (e.g., voice, modem, and the like), wireless communications media, and the like. For example, employed communications networks or links can include one or more wireless communications networks, cellular communications networks, G3 communications networks, G4 communications networks, Public Switched Telephone Network (NSTNs), Packet Data Networks (PDNs), the Internet, intranets, cloud computing networks, a combination thereof, and the like.

It is to be understood that the described devices and subsystems are for illustrative purposes, as many variations of the specific hardware used to implement the illustrative embodiments are possible, as will be appreciated by those alike in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to create the robustness and performance of the devices and subsystems of the illustrative embodiments.

The devices and subsystems of the illustrative embodiments can store information relating to various processes described herein. The information can be stored in one or more memories, such as hard disk, optical disk, magneto-optical disk, RAM, and the like, of the devices and subsystems of the illustrated embodiments. One or more databases of the devices and subsystems of the illustrative embodiments can store information used to implement illustrative embodiments of the present inventions. The database can be organized using data structures (e.g., records, tables, arrays, fields, graphs, pigeons, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof.

All or a portion of the devices and subsystems of the illustrative embodiments can be conveniently implemented using one or more general purpose computer systems, microprocessors, digital signal processors, micro-controllers, and the like, programmed according to the teachings of the illustrated embodiments of the present inventions, as well be appreciated by those skilled in the computer and software arts. Appropriate software can be readily prepared by programmers of ordinary skill based on the teachings of the illustrative embodiments, as will be appreciated by those skilled in the software art. Further, the devices and subsystems of the illustrative embodiments can be implemented on the World Wide Web. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present inventions can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the illustrative embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present inventions can be distributed for better performance, reliability, cost, and the like.

As stated above, the devices and subsystems of the illustrative embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

The above description of disclosed embodiments is provided to enable any person skilled in the art to make or use the invention. Various modifications to the embodiments will be readily apparent to those skilled in the art, the generic principals defined herein can be applied to other embodiments without departing from spirit or scope of the invention. Thus, the invention is not intended to be limited to the embodiments shown herein but is to be accorded the widest scope consistent with the principals and novel features disclosed herein.

What is claimed is:

1. A computer implemented system for interactively assessing a risk of developing drug toxicity, the system comprising:
a user input unit configured to receive objective and subjective information of a patient for a plurality of categories of patient data;
a correlation unit configured to determine a corresponding risk value of developing drug toxicity for each category of patient data, based on the patient data received in each category; and
a risk determination unit configured to determine a level of risk of a patient developing drug toxicity based on the correlated risk values.

2. The system of claim 1, further comprising:
a user interface configured to display different components of risk assessment including a metabolic pathway of a drug, an excretion pathway of a drug, potential drug sensitivity of a patient from prior experience, drug-to-drug and drug-to-food interaction, and Cytochrome P450 genotype.

3. The system of claim 1, further comprising:
a remote connection mechanism including a telemedicine connection, and a web server connecting to an appropriate application, for a user to virtually assess a patient, input patient data, and calculate a risk level of drug toxicity for the patient in real time.

4. The system of claim 1, further comprising:
a user interface configured to display risk levels corresponding to correlated risk values;
a multi-user platform configured to allow viewing of risk levels for allocation of clinician coverage in real time; and
a trend system configured to allow tracking of progress of an individual patient and accessible from a remote location.

5. The system of claim 1, further comprising:
a user interface configured to display different toxicity result levels accompanied by corresponding explanations for each of drug toxicity risk accompanied by suggestions of safer drug choices to mitigate drug toxicity, wherein each explanation is referenced for further reading.

6. The system of claim 1, further comprising:
a sorting system configured for sorting of patients with similar risk levels;
a display unit configured for representing by color indicators of similar risk levels;
a display screen or printable sheet for at-risk patients to improve clinician workflow;
an assessment tool configured for allowing for appropriate follow up for at-risk patients, including a visual screen configured for displaying at-risk patients simultaneously;
a visual system configured for improving continuity of care during shift changes;
a display device for submitting drug toxicity risks to patient outcomes reports, including a user interface configured to display when a risk level of a patient is at a predetermined level, and an inputted check list for drug toxicity prevention;
an automated documentation tool for clinicians configured to verify that drug toxicity prevention tasks are completed, including an automated process between drug toxicity assessment with data input completion of patient outcomes reports;
a user interface for real-time measurement of patient outcomes quality indicators, and a quality measurement linked to an individual user for an archived period;
a user interface for continuously transmitting drug toxicity risk levels;
an electronic message sharing system configured to send a message to a user group regarding drug toxicity risk levels;
a user interface for automated, updated assessment of risk level when a clinical condition of a patient changes, including automated reporting of urine output;
a documentation system configured for documenting when a clinician chooses a safer drug;
a user interface configured for interactive assessment for drug toxicity risk, wherein the user can change a variable input to view a changed display of toxicity level, accompanying explanations, and suggestions for alternate drugs; and
a user interface including a teaching tool that demonstrates various toxicity risk levels according to changing clinical parameters.

7. A computer implemented method for interactively assessing a risk of developing drug toxicity, the method comprising:
receiving via a user input unit objective and subjective information of a patient for a plurality of categories of patient data;
determining with a correlation unit a corresponding risk value of developing drug toxicity for each category of patient data, based on the patient data received in each category; and
determining with a risk determination unit a level of risk of a patient developing drug toxicity based on the correlated risk values.

8. The method of claim 7, further comprising:
displaying with a user interface different components of risk assessment including a metabolic pathway of a drug, an excretion pathway of a drug, potential drug sensitivity of a patient from prior experience, drug-to-drug and drug-to-food interaction, and Cytochrome P450 genotype.

9. The method of claim 7, further comprising:
providing a remote connection mechanism including a telemedicine connection, and a web server connecting to an appropriate application, for a user to virtually assess a patient, input patient data, and calculate a risk level of drug toxicity for the patient in real time.

10. The method of claim 7, further comprising:
displaying with a user interface risk levels corresponding to correlated risk values;
viewing with a multi-user platform of risk levels for allocation of clinician coverage in real time; and
tracking with a trend system progress of an individual patient and accessible from a remote location.

11. The method of claim 7, further comprising:
displaying with a user interface different toxicity result levels accompanied by corresponding explanations for each of drug toxicity risk accompanied by suggestions of safer drug choices to mitigate drug toxicity, wherein each explanation is referenced for further reading.

12. The method of claim 7, further comprising:
sorting with a sorting system patients with similar risk levels;
representing with a display unit color indicators of similar risk levels;
providing a display screen or printable sheet for at-risk patients to improve clinician workflow;
providing an assessment tool configured for allowing for appropriate follow up for at-risk patients, including a visual screen configured for displaying at-risk patients simultaneously;
providing a visual system configured for improving continuity of care during shift changes;
providing a display device for submitting drug toxicity risks to patient outcomes reports, including a user interface configured to display when a risk level of a patient is at a predetermined level, and an inputted check list for drug toxicity prevention;
providing an automated documentation tool for clinicians configured to verify that drug toxicity prevention tasks are completed, including an automated process between drug toxicity assessment with data input completion of patient outcomes reports;
providing a user interface for real-time measurement of patient outcomes quality indicators, and a quality measurement linked to an individual user for an archived period;
providing a user interface for continuously transmitting drug toxicity risk levels;
providing an electronic message sharing system configured to send a message to a user group regarding drug toxicity risk levels;
providing a user interface for automated, updated assessment of risk level when a clinical condition of a patient changes, including automated reporting of urine output;
providing a documentation system configured for documenting when a clinician chooses a safer drug;
providing a user interface configured for interactive assessment for drug toxicity risk, wherein the user can change a variable input to view a changed display of toxicity level, accompanying explanations, and suggestions for alternate drugs; and
providing a user interface including a teaching tool that demonstrates various toxicity risk levels according to changing clinical parameters.

13. A tangible, non-transitory computer readable medium including a computer program product for interactively assessing a risk of developing drug toxicity and having one or more computer readable instructions configured to cause one or more computer processors to perform the steps of:
receiving via a user input unit objective and subjective information of a patient for a plurality of categories of patient data;
determining with a correlation unit a corresponding risk value of developing drug toxicity for each category of patient data, based on the patient data received in each category; and
determining with a risk determination unit a level of risk of a patient developing drug toxicity based on the correlated risk values.

14. The computer readable medium of claim 13, further comprising computer readable instructions configured to cause one or more computer processors to perform the steps of:
displaying with a user interface different components of risk assessment including a metabolic pathway of a drug, an excretion pathway of a drug, potential drug sensitivity of a patient from prior experience, drug-to-drug and drug-to-food interaction, and Cytochrome P450 genotype.

15. The computer readable medium of claim 13, further comprising computer readable instructions configured to cause one or more computer processors to perform the steps of:
providing a remote connection mechanism including a telemedicine connection, and a web server connecting to an appropriate application, for a user to virtually assess a patient, input patient data, and calculate a risk level of drug toxicity for the patient in real time.

16. The computer readable medium of claim 13, further comprising computer readable instructions configured to cause one or more computer processors to perform the steps of:
displaying with a user interface risk levels corresponding to correlated risk values;
viewing with a multi-user platform of risk levels for allocation of clinician coverage in real time; and
tracking with a trend system progress of an individual patient and accessible from a remote location.

17. The computer readable medium of claim 13, further comprising computer readable instructions configured to cause one or more computer processors to perform the steps of:
displaying with a user interface different toxicity result levels accompanied by corresponding explanations for each of drug toxicity risk accompanied by suggestions of safer drug choices to mitigate drug toxicity, wherein each explanation is referenced for further reading.

18. The computer readable medium of claim 13, further comprising computer readable instructions configured to cause one or more computer processors to perform the steps of:
sorting with a sorting system patients with similar risk levels;
representing with a display unit color indicators of similar risk levels;
providing a display screen or printable sheet for at-risk patients to improve clinician workflow;
providing an assessment tool configured for allowing for appropriate follow up for at-risk patients, including a visual screen configured for displaying at-risk patients simultaneously;
providing a visual system configured for improving continuity of care during shift changes;
providing a display device for submitting drug toxicity risks to patient outcomes reports, including a user interface configured to display when a risk level of a patient is at a predetermined level, and an inputted check list for drug toxicity prevention;
providing an automated documentation tool for clinicians configured to verify that drug toxicity prevention tasks are completed, including an automated process between drug toxicity assessment with data input completion of patient outcomes reports;
providing a user interface for real-time measurement of patient outcomes quality indicators, and a quality measurement linked to an individual user for an archived period;
providing a user interface for continuously transmitting drug toxicity risk levels;
providing an electronic message sharing system configured to send a message to a user group regarding drug toxicity risk levels;
providing a user interface for automated, updated assessment of risk level when a clinical condition of a patient changes, including automated reporting of urine output;
providing a documentation system configured for documenting when a clinician chooses a safer drug;
providing a user interface configured for interactive assessment for drug toxicity risk, wherein the user can change a variable input to view a changed display of toxicity level, accompanying explanations, and suggestions for alternate drugs; and
providing a user interface including a teaching tool that demonstrates various toxicity risk levels according to changing clinical parameters.
